(19) United States
(12) Patent Application Publication
(10) Pub. No.: US 2011/0059213 A1
(43) Pub. Date: Mar. 10, 2011

(54) METHOD FOR PROCESSING WHOLE MUSCLE MEAT

(75) Inventors: Jennifer J. Anderson, Madison, WI (US); Jose C. Rojo, Waunakee, WI (US); David L. Moen, Waunakee, WI (US); Timothy D. Schnell, DeForest, WI (US); William T. Paulos, Madison, WI (US); Mark E. Malenke, Sun Prairie, WI (US)

(73) Assignee: Kraft Foods Global Brands LLC, Northfield, IL (US)

(21) Appl. No.: 12/875,521

(22) Filed: Sep. 3, 2010

Related U.S. Application Data
(60) Provisional application No. 61/239,675, filed on Sep. 3, 2009.

(51) Int. Cl. A23L 1/318

(52) U.S. Cl. 426/281; 426/324

(57) ABSTRACT

A method for producing a processed meat product begins at the supplier, where whole muscle meat is reduced into whole muscle meat pieces and the pieces may be macerated to increase their surface area. Prior to shipment of the whole muscle meat from the supplier to the meat processing plant, the whole muscle meat pieces are mixed with an initial ingredient mixture to create a raw base mixture and then packed into a container. The containers are shipped to a meat processing plant, whereby upon receipt of the raw base mixture at the processing plant, the raw base mixture is mixed with a customized ingredient mix to create a processed whole muscle mixture. The processed whole muscle mixture may then be stuffed and thermally processed.

### TECHNICAL FIELD

This invention relates generally to the processing of meat protein and, in particular, to processing whole muscle meat into a processed meat product.

### BACKGROUND

Processed meat products such as whole muscle products including chicken, beef, lamb, pork, e.g., ham, and turkey, are typically made in meat processing plants. Some commercial meat processing plants have facilities configured to remove the meat from the carcass, debone the meat, and produce processed meat products at a single location. Other commercial meat processing plants receive whole muscle meat that has already been deboned. Many supplier or packing facilities are located near farms where the animals are raised. Meat processing facilities are often located closer to large population centers, and in many cases are hundreds of miles or more from the supplier or packing facilities. It is anticipated that the distance from supplier to processing plants can be thousands of miles. Travel from the supplier facilities to the processing facilities can often take as much as 12 to 48 hours.

A processed or cured meat protein that has undergone protein extraction may be stored for a longer period of time than would otherwise be possible. That is, curing and protein extraction extend the shelf life of meat products. Curing to effect protein extraction typically takes a significant amount of time. To promote the protein extraction and cure the meat, a salt solution is used to promote the binding of proteins, salts, fats, and/or water. The salt solution may include sodium chloride, sodium phosphate, sodium nitrite, diphosphate, potassium chloride, sodium lactate, and potassium lactate, among others.

As is typical in many meat processing methods, various deboned whole muscle meats are supplied from a vendor or packing plant. Upon receipt of the deboned whole muscle meat at the meat processing plant, the curing and protein extraction process begins and is followed by further processing into the desired final meat product. Each of these steps can take a significant amount of space and time in the meat processing plant. For example, during the curing process, the whole muscle meat is collected in containers and stored in a cooler while the salt solution diffuses through the whole muscle meat, which can take 24-72 hours.

To accelerate the curing process, upon arrival at the meat processing plant, the whole muscle meat is sent through a pickle injector that employs hypodermic-type needles to puncture the meat and to injected a pickle solution through needles into the meat, as the meat travels through the pickle injector on a conveyor. The injector employs dozens of needles, referred to as a needle set, that travel upward and downward as a pickling solution is injected into the whole muscle. The needle set in some cases moves at around 15 strokes per minute. The length of time to complete the pickle injector step depends on the equipment used. By one approach, for approximately 2,000 lbs. of meat, the process will take between 10 and 15 minutes. Various pickle solutions may be employed for meat processing. Typical pickle solutions include a mixture of: water, salt, nitrite, ascorbate, erythorbate, phosphate, and sugar to note but a few ingredients. The pickle solution is prepared in a very specific process to ensure that all of the ingredients have dissolved properly and requires a specific sequence of steps to be followed to insure proper mixing. The injection step helps diffuse the pickle solution through the meat and also serves to tenderize the meat. Once the meat has passed through the injector, the size of the meat may be reduced, which can occur in a number of machines. For example, the meat can be reduced in size in a dicer, a grinder, or a macerator, to note but a few. After reduction of the whole muscle size, the meat is typically weighed and if the meat does not meet a certain target weight, additional pickle solution may be added. Then, the whole muscle chunks are combined with various ingredients such as spices or seasonings in a mixer or tumbler to further promote protein extraction and to mix the ingredients without excessively damaging the whole muscle meat pieces so that the meat retains its whole muscle appearance. Once this batch of whole muscle meat has been collected from the mixer or tumbler, the meat is stored in a cooler for 24-72 hours for curing of the meat. After the curing period, the meat undergoes a second mixing or tumbling process before being stuffed into casings, bags, or forms and thermally processed.

In general, processing the whole muscle meat requires a significant amount of plant time and plant space. The process typically requires numerous types of equipment, such as a pickle injector, a grinder, a macerator, and a mixer or a tumbler, to note but a few. The machines often have numerous moving parts that can be difficult to clean and repair. For example, the pickle injector has numerous pans, such as delicate needles, that can be difficult to repair and clean. Further, the pickle solution used with the injector is prepared in another process prior to the injection step. Various pickle solutions may be made for various final products as the pickle solution is often tailored to the desired final product; however, due to the very specific pickle preparation process, large batches of pickle are prepared and, thus, tailoring of the pickle is limited to the that which can be done in large batches. In addition, the vats of whole muscle pieces are stored in coolers in the plant for up to three days and such storage uses valuable plant space.

As mentioned, pickle solutions are typically made in large batches to take advantage of economies of scale. Batches of whole muscle product typically are also fairly large. Due to the large scale of the process, the capacity for customizing the meat into different final products with the pickle or dry ingredients can become limited.

### SUMMARY

The method disclosed herein comprises an improved method for making processed meat products including whole muscle meat products that may provide significant advantages with respect to the length of the process, the size and number of pieces of equipment required for processing, the control of the process, and other aspects of the process, such as the ability to customize the end product. As used herein, the term processed meat product indicates a meat protein that has undergone curing and/or mechanical action, which thereby extracts protein and extends the shelf life of the meat protein.

In one illustrative embodiment, the method begins at the meat supplier or vendor where whole muscle meat is reduced in size to whole muscle meat pieces and the meat pieces may be macerated. The macerated whole muscle meat pieces are combined with a concentrated or initial mixture prior to their being packaged and shipped to the meat processing plant, where the meat will be further processed into a finished food product. After receipt at the processing plant, the mixture of the whole muscle meat pieces and the initial mixture is further mixed with a customized ingredient mixture to tailor the incoming raw base meat mixture into a particular processed meat mixture, which may be stuffed and thermally processed into a processed meat product.

In another illustrative embodiment, the method begins at the meat supplier where the whole muscle meat is combined with a salt, a cure agent, and/or a curing accelerator. The whole muscle meat also may undergo processing to increase the surface area of the meat such as through maceration. These steps may all be accomplished prior to shipment of the meat to a meat processing plant. Curing and protein extraction, thus, may begin at the supplier and continue during transit. Upon arrival at the meat processing plant, the whole muscle meat that was previously combined with the salt, curing agent, and/or curing accelerator will have undergone protein extraction, or at least the protein extraction process will have been partially completed.

### BRIEF DESCRIPTION OF THE DRAWINGS

FIG. 1 is a flow diagram illustrating a process as described below; and

FIG. 2 is a chart comparing a previous process with one of the processes described below.

Certain actions and/or steps may be described or depicted in a particular order of occurrence while such specificity with respect to sequence is not actually required. Where such sequencing is of importance, such significance is noted.

### DETAILED DESCRIPTION

In one embodiment of the invention, a method for producing a processed meat product begins at the meat supplier where whole muscle meat may undergo an increase in its surface area. The increase in surface area can occur through a variety of means such as reduction in the size of the meat chunks, maceration, or a combination of both, to note but a few available options. By one approach, the whole muscle meat is reduced into whole muscle meat pieces and the reduced meat pieces are macerated. Prior to shipment of the whole muscle meat from the supplier to the meat processing plant, the whole muscle meat is mixed with an initial ingredient mixture and then the combination of the whole muscle meat and initial ingredient mixture is collected into a container. The containers are shipped to a meat processing plant. During transit from the supplier to the meat processing plant, the initial mixture, which may include a salt concentration or another cure or preservation agent, diffuses into the whole muscle meat, thereby beginning the curing process and creating a raw base meat mixture. Upon receipt at the meat processing plant, the raw base mixture is mixed with a customized ingredient mix to create a processed whole muscle mixture. The processed whole muscle mixture may then be stuffed and thermally processed to produce a processed whole muscle meat product.

To reduce the whole muscle meat into whole muscle meat pieces, a variety of different types of equipment may be employed. By one approach, reducing the meat to whole muscle pieces utilizes at least one of a macerator, a slicer, a kidney plate grinder, a dicer, a double macerator, a manual knife size reduction, a water jet, a harping unit such as a knife or wire harping unit, a slasher, a chopper, a grinder, and a laser cutter, to note but a few options. In addition, in one illustrative embodiment, once the whole muscle pieces have been reduced in size, the pieces are then macerated to further increase the surface area of the whole muscle meat pieces. An example of such macerator may be found in U.S. Pat. No. 5,145,453, the disclosure of which is incorporated herein by reference.

As mentioned above, in one illustrative embodiment, the reduced whole muscle meat pieces are combined with a concentrated or initial mixture prior to shipment of the meat to the meat processing plant. Alternatively, the whole muscle meat may be mixed with a concentrated or initial mixture directly after undergoing the deboning process. By one approach, the concentrated or initial mixture may include a salt concentration and a nitrite. By another approach, the initial mixture may include a salt, a nitrite, and a cure accelerator. The salt concentration may include sodium chloride, sodium pyrophosphate, diphosphate, potassium chloride, sodium lactate, and potassium lactate, among others. The cure accelerator may help ensure that the proper color of the meat is developed during processing and may include, for example, erythorbate, ascorbate, ascorbic acid, glucono-delta-lactone, and acid pyrophosphate, among others. Further, the nitrite may be a granular nitrite. In one exemplary embodiment, the salt concentration is sodium chloride, the nitrite is 100% granular nitrite, and the cure accelerator is an ascorbate, such as a sodium ascorbate. In addition, the sodium chloride salt concentration may be between 0.5% to 6% of the weight, the nitrite may be between 70 ppm to 200 ppm, and the sodium ascorbate concentration may be between 0 ppm and 547 ppm. By one illustrative approach, the sodium chloride solution may be between about 1% to 3% of the total weight of the whole muscle meat, the nitrite may be between about 70 ppm to 160 ppm, and the sodium ascorbate may be between about 250 ppm and 547 ppm. In one embodiment, the initial mixture added to the meat pieces is approximately a 2% (by weight of the meat) salt concentration, a 140 ppm of granular 100% nitrite, and 547 ppm granular sodium ascorbate. Also, though the previous example lists sodium ascorbate as the cure accelerator, erythorbate can be interchanged on approximately a one-to-one basis and, therefore, may be used in these amounts as the cure accelerator.

Further, it is anticipated that the ingredients in the initial mixture all may be added to the meat at the same time and the initial ingredients may or may not have been previously mixed together. Alternatively, the ingredients may be sequentially added to the meat such that one of the ingredients is mixed with the meat first and then subsequently another of the ingredients is added. For example, in one approach, the salt and nitrite is added to the meat, which is mixed for a period of time, and then the cure accelerator is added subsequent to the salt and cure, which is then mixed for an additional period of time.

After mixing of the meat with the initial mixture, the mixture may be chilled to a lower temperature. Further, it is anticipated that the initial ingredients may be added to the meat when the meat is still relatively warm or once the meat has cooled, as discussed more below. By one approach, the chilling may occur during the mixing process. In yet another approach, the chilling may occur subsequent to the mixing step. For example, the meat may be combined with the initial mixture and then chilled to a temperature of 40° F. or below. By one approach, the meat mixture will be chilled to a temperature of approximately 32° F. to 36° F. To accomplish such cooling, the mixer may be equipped with a cooling jacket or with gas ports that permit cooling gasses such as CO₂ to be injected into the mixer. It is also anticipated that the meat mixture may be cooled in a chiller to cool the mixture after mixing. Cooling the meat during the mixing step or shortly thereafter can be important for final product quality.

As containers of the whole muscle meat and initial mixture are transported to the meat processing plant, the initial mixture diffuses into the whole muscle meat such that a raw base material is created. Upon arrival at the meat processing plant, the raw base meat has undergone at least some protein extraction and cure color development. Once the raw base material of whole muscle meat having the initial mixture at least partially diffused therein arrives at the meat processing plant, the raw base material may be combined and mixed with a second mixture that may be a customized ingredient mix to produce a processed whole meat mixture. For example, if a honey ham product is desired, the raw base material may be combined with a customized ingredient mix that includes honey, among other ingredients. The customized ingredient mix may include, e.g., salt, sugar, phosphates, ascorbate, erythorbate, brown sugar, honey, spices, mesquite seasonings, and other flavorings.

By increasing the surface area of the meat and/or reducing the size of the meat at the supplier and mixing the reduced meat pieces with a first, initial mixture before shipment, the time the meat spends in transit is used productively, thereby beginning the protein extraction and color development process prior to arrival at the processing plant. In addition, by combining the raw base meat mixture with a second or customized mix, the product can be specifically tailored to consumers' demands. By allowing the transit time to be used productively, the pickle injection process may be bypassed, which in turn frees up additional plant space and processing time. Forgoing the pickle solution also reduces wasted pickle solution that is surplus to production needs, thus saving wasted costs. Further, by having the base meat mixture at least partially cured while in transit, plant space is not taken up by having containers of meat curing for 24-72 hours as previously required. As a result, the process acquires some additional flexibility such that the raw base mixture may be processed into a variety of whole muscle meat products upon arrival at the meat processing plant. Those skilled in the art will recognize and appreciate that these teachings are suitable for use with a number of existing processes and equipment in this regard and also that these teachings are highly scalable and hence usable in a number of application settings. For example, upon arrival at the meat processing plant the base meat mixture may be mixed or tumbled with standard batch-processing equipment, or also may be processed through a continuous mixer that is capable of receiving constituents at an input end of the mixer while simultaneously discharging a processed meat mixture at an output end.

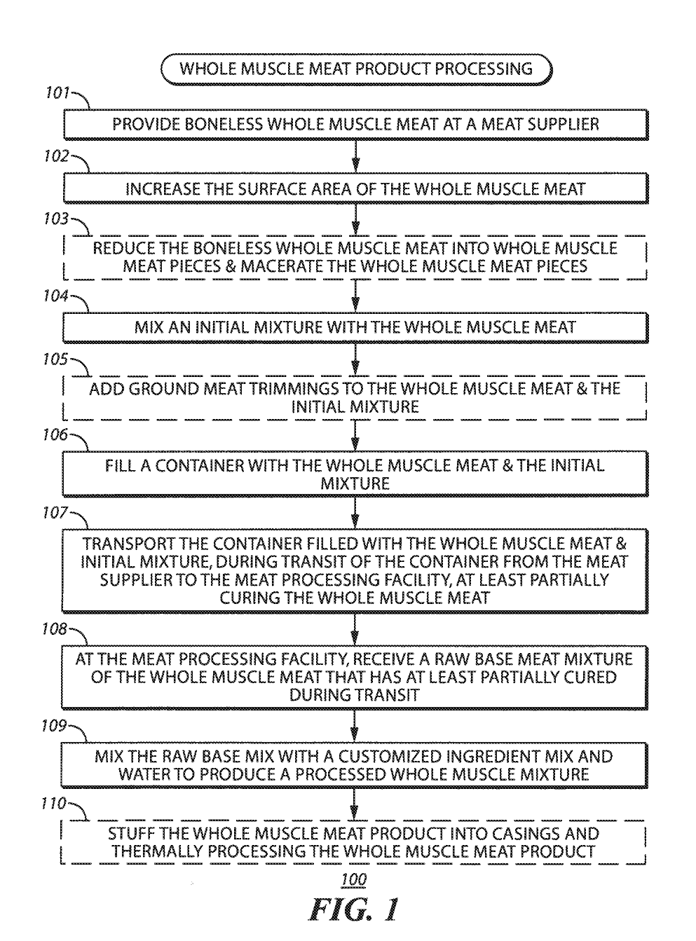

These and other benefits may become clearer upon making a thorough review and study of the following detailed description. Referring now to the drawings, and in particular to FIG. 1, an illustrative process that is compatible with many of these teachings will now be presented. A whole muscle meat process 100 comprises providing 101 boneless whole muscle meat. The whole muscle meat provided has been removed from the carcass and deboned, which may occur at the supplier or packing plant or, alternatively, may arrive at the supplier plant already deboned. The meat protein provided may include turkey, chicken, ham, beef, or lamb.

By one approach, the whole muscle meat will be cooled prior to deboning. By another approach, the whole muscle meat will be deboned and removed from the carcass prior to undergoing significant cooling. In one conventional process, the whole muscle meat is permitted to cool prior to the deboning process. However, removal of warm meat is sometimes used during the making of sausage-type products, as opposed to whole muscle products. Further, such warm or hot deboning was generally not been used for whole muscle products due to the concerns regarding post-deboning cooling that can cause the whole muscle meat to contract and harden, sometimes termed cold shortening. After contracting and hardening, the cooled whole muscle meat may become nearly inedible in some circumstances. Thus, the meat is typically permitted to cool prior to the deboning process; however, if hot deboned meat is used steps should be taken to decrease the impacts of cold shortening as described below.

In one alternative approach, the hot or warm whole muscle meat may be deboned and then shortly thereafter the warm deboned meat may be combined with a salt and cure mixture. Combining the warm, deboned meat with a salt and/or a cure solution promptly after deboning the warm meat, prevents or limits the amount of contraction or shrinking of the whole muscle meat. Thus, by promptly combining the warm deboned meat with a salt and/or cure solution, the desired whole muscle quality of the product is preserved. By one approach, the combination may promptly occur such that the warm, deboned meat is combined with the salt or cure solution prior to cooling of the whole muscle meat. Certain factors, such as the type of meat being processed and the manner of deboning, may impact how promptly the warm meat is combined with the salt and/or cure ingredients. It is anticipated that the meat may be combined with the salt and/or cure within a few hours. For example, hot or warm deboned pork may be combined with the ingredients within about 60 minutes, whereas poultry may be combined within about 15 to 30 minutes. Furthermore, the speed at which the combination occurs may depend on the manner employed to debone or process the meat.

Prior to being shipped to the meat processing plant, the whole muscle meat undergoes an increase 102 in the surface area of the whole muscle meat. By one approach, the increase 102 of surface area can occur by reducing 103 the size of the meat into whole muscle meat pieces and/or macerating the whole muscle meat. In one illustrative approach, the whole muscle is both reduced in size and then the whole muscle meat pieces are then macerated. The whole muscle meat size reduction can occur in a slicer, a kidney plate, a grinder, a dicer, a macerator, a double macerator, a manual knife size reduction, a water jet, a harping unit such as a knife or wire harping unit, a slasher, a chopper, and a laser cutter, to note but a few options. Once the piece size has been reduced, the whole muscle meat pieces may be macerated, which can occur in various maceration equipment. A typical macerator is configured to increase the surface area through the use of rotating blades, spiked teeth, or other protrusions that contact the meat to cut the surface of the muscles or protrude into the muscle thereby opening up or stretching the surface of the whole. By one approach, once the whole muscle meat is reduced in size in a macerator, the whole muscle meat pieces are again macerated through the maceration equipment. By another approach, the whole muscle meat is reduced in size through a slicer and then run through a macerator. In yet another illustration, the whole muscles are not broken up or reduced in size but are worked, i.e., stretched, crushed, punctured, to increase the surface area of the whole muscles without resulting in an overall reduction in the size of the whole muscles. Further, the process of stretching, crushing, and puncturing the meat results in breaking down the muscle cells or ruptured muscle cells walls, which further facilitates diffusion of salt ions into individual muscle cells of the meat.

More particularly, using a macerator to crush, stretch, or puncture, results in a break down or rupturing of the individual whole muscle cells. While such working of the meat may also increase the surface area on a larger scale to promote diffusion of the ingredients, such a working may breakdown the cells walls on a much smaller scale. This breakdown or rupturing of the cell walls can occur without drastically affecting the overall whole muscle character of the meat. Further, this breakdown facilitates diffusion of the initial mixture ingredients into the whole muscle meat. In sum, penetration of the initial ingredients is improved when the cell walls have broken down or ruptured and the ingredients of the initial mixture are more easily and quickly absorbed by the meat subsequent to the rupturing of some of the individual cell walls.

In one illustrative aspect, the whole muscle meat is macerated by passing through counter-rotating shafts and arbors in an axial plane. The arbors having an integral assembly of alternating radically projecting and axially extending teeth members and space members. By one approach, such an arbor includes radial extending teeth from one arbor that compress the meat into a channel on the opposing arbor. The counter-rotating arbors are positioned on a frame generally parallel to and in alignment with each other and the arbors are spaced apart such that the teeth of one arbor extend into the channel of the other arbor. The particular depth with which the teeth extend may depend on the particular design and on the space between the arbors when they are mounted onto the frame. Further, in one example, the space between the arbors may be adjusted based on the final desired meat product.

It is anticipated that certain operational parameters or configurations of the macerators may provide a reduction in size of the whole muscle meat, whereas other configurations and operational parameters may primarily increase the surface area of the whole muscle meat pieces and rupture at least some muscle cell walls of the meat without a significant reduction in the whole muscle size. The level of working done to the meat (whether the whole muscle meat will be reduced in size or merely worked to increase the surface area and rupture at least some muscle cells without reducing the size of the muscles) may not only depend on the configuration of the apparatus but also on the operational parameters. Therefore, equipment that may typically increase the surface area of the whole muscles without separating the muscles into smaller pieces may, indeed, reduce the size of the whole muscle pieces if operated at certain speeds, clearances, tolerances, and/or conditions.

In one illustrative embodiment, the whole muscle meat is reduced 103 to whole muscle meat pieces with an average thickness between approximately one-quarter inch to three inches. By one approach, the whole muscle pieces have an average thickness of about one inch. Several considerations affect how the whole muscle meat pieces are reduced. Smaller meat piece size results in less distance through which the salt diffuses and numerous smaller pieces will have a larger combined surface area through which the ingredients will combine and penetrate, than would a large whole muscle meat. Nonetheless, it is desirable for whole muscle products to retain their overall whole muscle meat integrity; therefore, it is not desirable for the whole muscle pieces to be excessively reduced in size. An average thickness of between one-quarter to three inches generally provides a thickness through which the salt may diffuse in a relatively efficient manner, while still retaining the overall whole muscle meat structure. Further, the size of the piece reduction and the manner of size reduction may depend on the desired end product. For example, some consumers may be interested in an emulsified meat product similar to a hot dog and, therefore, quite significant piece size reduction may occur at the packing plant. Alternatively, certain consumers may be interested in a meat product that has retained nearly its entire whole muscle meat appearance and, thus, the whole muscle meat will not have undergone reduction in the whole muscles. Further, to obtain sufficient diffusion through large whole muscles, the first initial mixture and second mixture may be altered to compensate for the larger muscle pieces.

As mentioned above, to reduce the size of the whole muscle meat a number of apparatus may be utilized. For example, a slicer may be configured to cut the meat into the desired meat piece size. Further, a kidney plate or grinder could be used, which would reduce the whole-muscle size by working the meat through large holes in the kidney plate. In addition, a dicer could be configured to work or dice the meat at a lower setting so as to cut or chop the whole muscles into meat pieces without mincing the meat. Another apparatus that may be used to reduce piece size is a macerator or a double macerator, which may also be used to increase the surface area of the reduced muscle meat pieces. As used herein, the macerator refers to an apparatus that physically works the whole muscle meat and as described above, though the macerator may be configured to increase the surface area without reducing the size of the muscles, it is also anticipated that the macerator may be configured to operate such that the muscle undergo a reduction in size. The macerator may have a set of parallel shafts with rotating elements such as blades or spiked teeth, wherein the parallel shafts can be adjusted to provide a larger or smaller gap between the rotating elements or to provide that the rotating elements overlap or mesh with one another, depending on the amount of work to be applied to the whole muscle meat. During operation, the meat is advanced in between the two rotating shafts. The whole muscle meat is forced through the rotating shafts such that the blades or gears abrade, cut, puncture, or stretch the whole muscle to thereby increase the surface of the whole muscle meat and rupture a portion of the muscle cells. The configuration of the shafts, distance between the shafts, rotational speeds of the shafts, and other factors may contribute to amount of work done to the whole muscles.

In one illustrative embodiment, after the pieces have been reduced in size, the whole muscle pieces may undergo a maceration step to further increase the surface area of the whole muscle pieces to assist with diffusion of the salt and accelerate protein extraction and facilitate color development. If the whole muscle meat is reduced to pieces in a macerator, the meat may undergo a second maceration process to further increase the surface area of the meat pieces. Further, a double macerator may be used to both reduced whole muscle meat size and increase the surface area of the meat pieces and rupture a portion of the muscle cells. There are a number of configurations of equipment that could be employed to accomplish the size reduction-surface area increase. The specific equipment employed may depend on the desired finished meat product characteristics and application.

Upon completion of the muscle piece size reduction and/or surface area increase, an initial mixture will be combined 104 with the whole muscle meat pieces. For example, the ingredients could be added by hand or though a dry ingredient dispersion system. The initial mixture, by one approach, is a dry cure mix or a concentrated mix that facilitates protein extraction without adding, or adding very little additional water. More particularly, the initial mixture may include a salt concentration, nitrite, and a cure accelerator. By another approach, the initial mixture may be a concentrated liquid. For example, the initial mixture may include a concentrated vegetable juice that naturally contains nitrites and/or nitrates, without any added water. It is also anticipated that the cure accelerator may be from a natural, plant-based source such as a cherry powder, which contains ascorbic acid naturally. If a vegetable juice is used in the initial mixture, the ingredients may be added by a wet ingredient dispersion. Thus, the salt concentration may be a dry or liquid mixture and may include a number of different salts.

Whether the initial mixture is a dry or liquid mixture, it is contemplated that the amount of water added to the meat will be minimized. Indeed, the concentrated initial mixture may have limited or no water added. It is anticipated that the water added will be less than 5% wt. based on the weight of the meat. By another approach, less than 3% water may be added. By yet another approach, less than 1% water is added. In another alternative embodiment, no additional water may be added (outside of what is already contained in the meat protein). By minimizing the amount of water added, the shipping weight is also minimized such that the weight of the shipped containers is not unduly increased, which could increase the cost and difficulty of shipping. However, if water is added, it typically will be less than the water added during further processing at the meat processing plant. As used herein “a dry cure mix” is not intended to denote that the products produced therewith will necessarily be “dry cured” under 9 C.F.R. 319.106(c). Instead, the dry cure mix is a term directed to the first, initial mixture or concentrated amount of initial ingredients added to the whole muscle meat prior to shipping. Nonetheless, a “dry cured” meat similar to that obtained in the process outlined in the regulations without the required length of cure time can be obtained by using the process described herein with a dry initial mixture. By preparing the meat by increasing the surface area, the initial mixture may cure the meat in a quicker amount of time than is otherwise required.

The nitrite discussed above may include any of a variety of nitrites including those chemically produced or those naturally derived, such as from plant-based sources. Further, it is contemplated that the concentrated mix may use other ingredients to ensure freshness of the final product such as alternative preservation ingredients, which can include a variety of alternative ingredients including those with antimicrobial properties such as natural fermantates or conventional fermantates typically produced in a chemical process. Other alternative preservation ingredients may include ascorbic acid, sodium ascorbate, and any of a variety of antioxidants, just to note a few. As used herein, the term alternative preservation may refer to a wide variety of ingredients that are not conventional nitrites. The alternative preservation ingredients could be added to the meat as a concentrated dry or liquid mixture. Whether dry or liquid, the initial mix is typically concentrated to avoid extra weight thereby facilitating protein extraction and curing without adding unnecessary weight to the shipping containers. If the preservation system is a liquid, a hand or liquid ingredient dispersion system may be used to add the ingredients to the whole muscle meat.

By one approach, the dry cure or initial mixture includes at least a salt concentration, nitrite, and a cure accelerator. The salt concentration may include sodium chloride, sodium pyrophosphate, or diphosphate, potassium chloride, sodium lactate, and potassium lactate, among others. Further, the nitrite may be a granular nitrite. The cure accelerator may help ensure that the proper color of the meat is developed during processing and may include, for example, erythorbate, ascorbate, ascorbic acid, glucono-delta-lactone, and acid pyrophosphate, among others. In one exemplary embodiment, the salt concentration is sodium chloride, the nitrite is 100% granular nitrite, and the color accelerator is an ascorbate. Further, the salt concentration added to the whole muscle meat may include about 1% to 3% of the weight of the meat, the nitrite may include a granular 100% nitrite of approximately 70 pppm to 200 ppm, and the sodium ascorbate concentration may be between 0 ppm to 547 ppm. In one exemplary embodiment, the initial mixture includes a 2% salt concentration 140 ppm of nitrite, and the ascorbate may be between about 400 ppm and 547 ppm.

### Example 1

A raw meat batter suitable for accelerated processing upon arrival of the meat protein at the processing plant may be prepared by combining 100 lbs. of boneless whole muscle ham with 3 lbs. of sodium chloride, 0.0156 lbs. of sodium nitrite, and 0.05 lbs. of sodium ascorbate at the supplier packing plant. The sodium chloride, sodium nitrite, and sodium ascorbate may be added together or may be added sequentially. For example, the sodium chloride may be added, followed by the sodium nitrite and then followed by the sodium ascorbate or all three ingredients may be added to the boneless ham at the same time. In another approach, the sodium chloride and sodium nitrite may be added together with the boneless whole muscle meat, followed by the sodium ascorbate. When all of the ingredients have been mixed together, such as in a tumbler, the total weight is approximately 103.0656 lbs. Further, the total weight does not include any water added and, therefore, until this meat mixture arrives at the processing plant for additional processing, the only water present is that contained within the whole muscles. Other examples are provided below in table 1.

TABLE 1

| | Weight | | Weight |
|---|---|---|---|
| Ingredient | Lbs. | Ingredient | Lbs. |
| Example 2 | | Example 3 | |
| Turkey Breast | 100 | Lean Beef Muscles | 100 |
| Salt (Potassium chloride) | 1 | Sodium Lactate | 2 |
| Sodium Nitrite | 0.012 | Sodium Nitrite | 0.014 |
| Sodium Erythorbate | 0.05 | Sodium Ascorbate | 0.025 |
| Added Water | 0 | Added Water | 0 |
| Total | 101.062 | Total | 102.039 |
| Example 4 | | Example 5 | |
| Chicken Breast | 100 | Boneless Ham | 100 |
| Salt (Sodium chloride) | 2 | Salt (Sodium chloride) | 1 |
| Sodium Nitrite | 0.0156 | Sodium Nitrite | 0.0200 |
| Sodium Ascorbate | 0 | Sodium Erythorbate | 0.05 |
| Added Water | 0 | Added Water | 4 |
| Total | 102.0156 | Total | 105.07 |
| Example 6 | | Example 7 | |
| Chicken Breast | 100 | Chicken Breast | 100 |
| Salt (Sodium chloride) | 2 | Salt (Sodium chloride) | 1 |
| Sodium Nitrite | 0.0200 | Cultured Celery Juice | 0.6 |
| Ascorbic Acid | 0.04 | Cherry Powder | 0.16 |
| Added Water | 2 | Added Water | 0 |
| Total | 104.06 | Total | 103.02 |

As can be seen, a variety of combinations may be available for the initial mixture. Further, while some have a very limited amount of added water or other liquids such as a vegetable juice, the amount of water added is generally less than about 5% wt. based on the weight of the meat.

The mixing step may be accomplished by a mixer, tumbler, massager, a continuous mixer, or merely adding the ingredients together in a container for further mixing during typical shipping movements encounter during transit. By one approach, the first, initial mix and the whole muscle meat pieces are combined or blended in a mixer, such as a continuous mixer, or a tumbler for less than about fifteen minutes.

Depending on the desired final end product, ground meat trimmings and/or other meat ingredients may be added 105 to whole muscle along with the initial mixture. For example, whole muscle ham may have ham trimmings added at different percentages ranging from approximately 5 to 25% in one approach. While meat trimmings may be added to the meat mixture at the subsequent, processing facility, it may aid distribution if the trimmings are added at the supplier facility along with the initial mix.

After combining 104 the initial mix with the whole muscle meat pieces, the mixture may be collected in a container such as a corrugated or large plastic container. By one approach, the container includes a lid to enclose the whole muscle meat pieces and the initial mixture within the container. Further, the container may be airtight to assist in preserving the freshness of the food product contained therein and to prevent contamination. Once containers have been filled 106 with the whole muscle meat and the initial mixture, the containers are ready for shipment.

While it is anticipated that the meat will be transported to the meat processing facility, after deboning and further treatment (such as by reducing the whole muscle meat into pieces or by increasing the surface area through maceration), for certain desired finished products the whole muscle meat may be mixed with the initial concentrated mixture and then transported to the processing facility without any further treatment. For example, after deboning of the whole muscle meat, the meat may be mixed with an initial mixture, loaded into containers and, then shipped to the meat processing facility.

As illustrated in method 100 after loading or filling 106, the containers are transported 107 from the supplier-packing plant to the meat processing plant. During transportation, the whole muscle meat is able to cure such that upon arrival at the meat processing plant, a raw base meat mixture arrives that has already begun the protein extraction and color development process. As mentioned above, the meat supplier facility and the meat processing facility can be located a significant distance apart from one another and, thus, the transit time from one location to another can become significant. In addition, the whole muscle meat may have undergone an increase in surface area and rupture of muscle cell walls and, thus, the salt of the initial mixture is able to more easily and quickly diffuse through the meat. The containers are typically shipped in refrigerated over-the-road trucks, though other shipment methods are contemplated.

At the meat processing facility, the containers are received 108 with a raw base material therein. The raw base material includes the whole muscle meat pieces that have at least partially cured during transit. During the transit and curing process, the initial mixture has diffused into the whole muscle meat pieces. Previous manufacturing processes required that the meat cure at the processing plant after being injected with a pickle solution via a pickle injector with hypodermic-type injection needles. However, the whole muscle meat pieces being shipped with the initial mixture may not require pickle injection. Thus, process 100 may not require the pickle injection step typically required for processed meats. Eliminating the pickle injection steps also eliminates the need to prepare the pickle solution.

Upon arrival at the meat processing plant, the raw base meat mixture may be further processed to customize the raw base meat mixture into a particular desired food product. For example, a raw base meat mixture of ham may be customized into a mesquite ham, a honey baked ham, or low-fat honey ham, among many others. To this end, after the meat has been transported to the meat processing plant, the raw base mixture is combined or mixed 109 with a customized ingredient mix and water. By one approach the customized ingredient mix may include salt, sugar, phosphates, ascorbates, erythorbates, brown sugar, honey, flavorings including spices, mesquite seasonings, sea salt, vinegar, sodium lactate, sodium diacetate, and liquid smoke flavoring, to note but a few. Water may also be added with the customized ingredient mix. The amount of water added may depend on the desired final product. For example, a lower fat whole muscle meat may have a larger amount of water added to the mix. By one approach, the water added with the customized ingredient mix may be approximately 20 to 25% by weight. Alternatively, a product similar to the “dry cured” meat may require the addition of little or no water or other liquid. By one approach, the phosphates may include tetrasodium pyrophosphate, potassium tripolyphosphate, and/or sodium tripolyphosphate, among others. Since the customized ingredient mix is added after a significant amount of the curing process has already occurred, certain ingredients added in the customized ingredient mix will need to be those which can be more quickly absorbed or more quickly dissolved. For example, the phosphate added with the customized ingredient mix may include a type of pyrophosphate that is suitable for quick absorption.

A variety of equipment may be used to combine or mix the customized ingredient with the raw base meat mixture, including a mixer, a continuous mixer, a massager, and a tumbler. In one illustrative embodiment, the customized ingredient mix may be combined with the raw base meat mixture in a tumbler or mixer for a period of time, such as approximately less than about fifteen minutes. By another approach, the ingredients are mixed for less than approximately 5 minutes. In one illustrative embodiment, the customized ingredient mix may be combined in a continuous meat mixer configured to receive input ingredients as the processed meat mixture is discharged at an output. By yet another approach, the customized ingredient mix is mixed with the raw base material in a tumbler for less than 90 minutes.

After mixing 109 the raw base mix with a customized ingredient mix and water to produce a processed whole muscle mixture, the mixture may be stuffed 110 into casings, bags, or forms or otherwise prepared for thermal processing to produce a finished whole muscle meat product. While conventional processing typically requires significant cure time after mixing, process 100 is configured to permit stuffing 110 of the whole muscle meat relatively shortly after mixing 109. Conventional cure hold times for whole muscle meats might be in the range of a number of hours, such as 12 to 72 hours for red meat. In one illustrative embodiment, the whole muscle meat is stuffed 110 into the casings within an hour after the mixing 109 in the processing plant. In another approach, the meat is stuffed 110 within 4 to 5 hours. By yet another approach, the meat is stuffed 110 within 8 to 10 hours of the mixing. The time frame may depend on the particular meat and ingredient mix combined and the manner of mixing 109. By yet another approach, the stuffing 110 may occur within minutes of the mixing 109. Thermal processing is begun shortly after the stuffing process and may include cooking the stuffed meat logs at a temperature of above 150° F. Cooking times generally vary depending upon the process and intensity of the heat applied. It is anticipated that the cook time may range from about 3 to 8 hours, though other cook times are contemplated.

In addition to whole muscle meat products mentioned above, the raw base meat mixture could be used to make a meat emulsions such as for bologna, hot dogs, loafs, and loaf products with a varying degree of whole muscle meats. For example, depending on the type of final meat product desired, the mixing of the raw base mixture with the customized ingredient mixture may be more vigorous. In addition, the particular customized ingredient mixture that is combined with the raw base mixture will depend on the desired final meat product. For example, if pimento loaf is the desired final product, the customized ingredient mix might include chopped pickles and pimentos along with other ingredients.

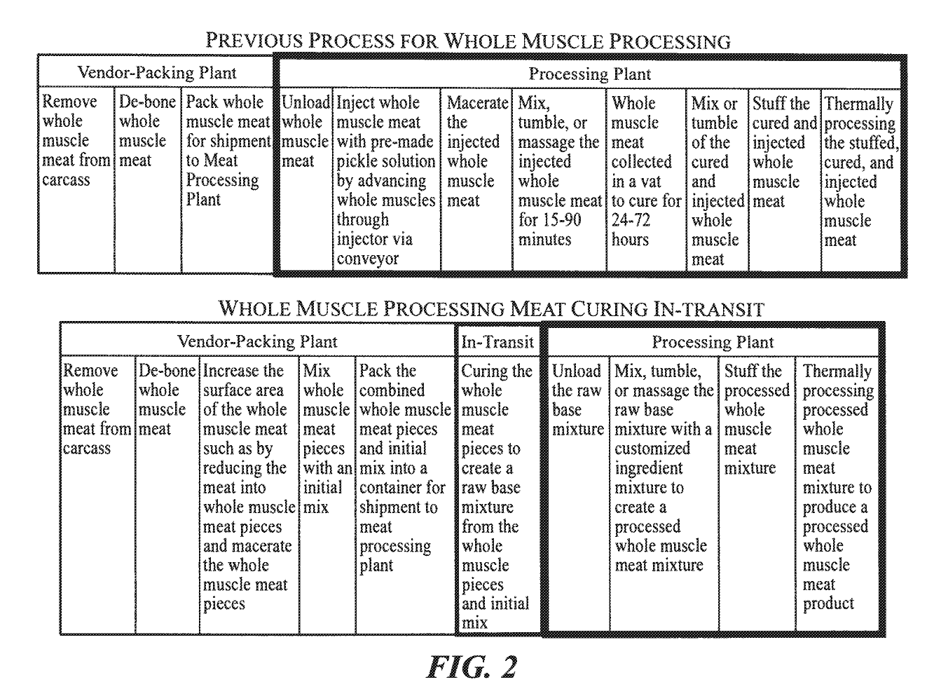

One illustrative example, shown in FIG. 2 as process 200 shows that some steps (including the steps of removing the meat, deboning the whole muscle meat, reducing the whole muscle into whole muscle meat pieces, macerating the meat pieces, and mixing the meat pieces with an initial mixture before packing the meat into containers) occur outside of the meat processing plant. As discussed above, not all of these steps are required to produce whole muscle meat, but process 200 is one method of efficiently producing a processed whole muscle meat product. Further, by mixing the whole muscle meat pieces with the initial mix in process 200, the whole muscle meat is able to begin curing during transit from the vendor or packing plant to the meat processing plant. While the transit time between the vendor packing plant and the processing plant varies based on the distance between the two locations, it is anticipated that the transit time will likely be longer than two hours and possible up to 72 hours, though in one illustrative embodiment the transit time is between 12 and 48 hours. Upon arrival at the meat processing plant, a raw base mixture, which has already undergone significant protein extraction and cure color development, is unloaded. As illustrated, when the whole muscle meat is unloaded at the meat processing plant, the whole muscle raw base meat is further mixed with a customized ingredient mixture to create a whole muscle meat mixture that can be stuffed and thermally processed 110 into a finished whole muscle meat product. A variety of equipment may be used to mix the customized ingredient mixture with the raw base material such as a mixer, tumbler, and a massager, which may also be continuous or batch process equipment. Process 200 does not require the pickle injector with the numerous hypodermic-type needles that inject the whole muscle meat with the pickle solution. Further, process 200 does not require the preparation of a pickle solution. The meat protein processed according to method 200 arrives at the meat processing plant ready for customization and is quickly processed into a whole muscle meat product and ready for shipment to consumers relatively soon after arrival at the meat processing plant. In addition to eliminating the need to the pickle injection, process 200 also decreases the cure time required at the processing plant and also reduces the mix time due to the sequencing of ingredients and the addition of ingredients at the vendor-packing plant.

As illustrated in process 201 of FIG. 2, after the whole muscle meat is unloaded at the meat processing plant, the meat undergoes a pickle injection process where the meat is injected with a pickle solution that promotes protein extraction and tenderizes the meat. During the injection step, the whole muscle meats are punctured with the moving hypodermic-type needles that inject the pickle solution through the needles into the meat. For whole muscle products, delivery of the brine solution through injection of the needles inserted into the meat chunks is a relatively imprecise method for attempting to reduce the distance through which the salt must diffuse. Following the injection step, the whole muscle is mixed, tumbled, or massaged for approximately 15-90 minutes, possibly under vacuum conditions to remove air from the system. After mixing, tumbling, or massaging, the curing stage typically requires 24-72 hours for satisfactory diffusion, and the batches are stored in vats and placed into coolers for the cure time. Once the protein extraction has occurred, the mixture may then be further processed. Further processing, as noted in process 201 includes mixing, tumbling, or massaging of the cured meat, stuffing, and thermally processing. As seen in FIG. 2, process 201 requires significantly more time and work at the meat processing facility, as compared to process 200. Further, since the whole muscle meat must typically undergo transit time from the vendor/packing plant to the processing plant, by employing the transit time to undergo curing (color development) or protein extraction, the whole muscle meat may be more quickly processed for delivery to the consumer.

The processes 100, 200 are flexible and highly scalable. While the amount of whole muscle meat processed by processes 100, 200 may vary, it is anticipated that a shipment of the whole muscle meat from the supplier can be between 1,000 to 55,000 lbs. By one approach, the incoming shipment will be divided into a number of lots to be further processed as described above.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for preparing a raw base material for use in a processed meat product, the method comprising:
at a meat packing plant, deboning whole muscle meat to thereby create boneless whole muscle meat having a surface area;
increasing the surface area of the whole muscle meat at said meat packing plant;
mixing an initial mixture with the whole muscle meat at said meat packing plant;
packing the whole muscle meat and the initial mixture into a container at said meat packing plant; and
shipping the container with the whole muscle meat and the initial mixture to a meat processing plant such that the initial mixture is in contact with said whole muscle meat over a time period of at least 2 hours such that the initial mixture has the effect of at least partially processing the whole muscle meat during shipping.

2. The method of claim 1, wherein increasing the surface area of the whole muscle meat comprises reducing the whole muscle meat into whole muscle meat pieces.

3. The method of claim 2, wherein increasing a surface area of the whole muscle meat further comprises macerating the whole muscle meat pieces to further increase the surface area of the whole muscle pieces.

4. The method of claim 2 wherein reducing the whole muscle meat to whole muscle meat pieces utilizes at least one of:
a macerator;
a slicer;
a kidney plate;
a dicer;
a double macerator;
a manual knife size reduction;
a water jet;
a harping unit;
a slasher;
a chopper;
a grinder; and
a laser cutter.

5. The method of claim 4 wherein the macerator includes first and second arbors configured to counter-rotate during operation wherein at least one of the first and second arbors has protrusions that extend into channels of the other of the first and second arbors.

6. The method of claim 6 wherein the first and second arbors have an integral assembly of alternating radially projecting and axially extending protrusions and channels.

7. The method of claim 2 wherein the initial mixture comprises at least one of:
a salt concentration;
a nitrite;
a cure accelerator; and
an alternative preservation ingredient.

8. The method of claim 7 wherein the cure accelerator includes at least one of:
erythorbate;
ascorbate;
ascorbic acid;
glucono-delta-lactone; and
acid pyrophosphate.

9. The method of claim 7 wherein the mixing of the initial mixture with the whole muscle meat occurs in steps such that the salt concentration and the nitrite area mixed with the whole muscle meat prior to the mixing of the cure accelerator.

10. The method of claim 7 wherein the mixing of the initial mixture with the whole muscle meat occurs such that all ingredients of the initial mixture are mixed simultaneously.

11. The method of claim 2 wherein the initial mixture comprises a salt concentration of about 0.5% to 6% of the weight of the whole muscle meat pieces and further comprises 70 ppm to 160 ppm of nitrite and less than about 500 ppm of sodium ascorbate.

12. The method of claim 2 wherein the initial mixture comprises a salt concentration and nitrite and at least one of:
flavorings;
water; and
additional cure components.

13. The method of claim 2, wherein the whole muscle pieces have an average thickness of approximately ¼ in. to 3 in.

14. The method of claim 2 further comprising adding ground meat trimmings and other meat ingredients to the whole muscle pieces along with the initial mixture.

15. The method of claim 2, wherein mixing the initial mixture with the whole muscle meat pieces further comprises mixing the initial mixture and the whole muscle meat pieces in a mixing apparatus for less than about fifteen minutes.

16. The method of claim 2 further comprising cooling the combined whole muscle meat and the initial mixture.

17. A method for customizing a raw base material into a whole muscle meat product at a meat processing plant, the method comprising:
receiving a raw base material of whole muscle meat pieces and initial mixture that have been shipped from a packing plant and arrives at the meat processing plant having undergone at least some protein extraction and color development;
mixing the raw base material with a customized ingredient mix thereby creating a processed whole muscle mixture;
thermally processing the processed whole muscle mixture to produce a cooked processed whole muscle meat product.

18. The method of claim 17, wherein the customized ingredient mix includes at least one of:
salt;
sugar;
phosphates;
ascorbate;
sodium erythorbate;
brown sugar;
honey;
flavorings;
mesquite seasonings;
sea salt;
vinegar;
sodium lactate;
sodium diacetate; and
liquid smoke flavoring.

19. The method of claim 17 wherein the raw base material is mixed with the customized ingredient mix in at least one of:
a mixer;
a continuous mixer;
a massager; and
a tumbler.

20. A method of processing whole muscle meat, the method comprising:
deboning whole muscle meat to thereby create boneless whole muscle meat;
reducing the whole muscle meat into whole muscle meat pieces and macerating the whole muscle meat pieces to increase surface area and rupture at least some individual muscle cell walls of the whole muscle meat pieces;
mixing a first mixture with the whole muscle meat pieces;
packing the whole muscle meat pieces and the first mixture into a container;
transporting the container with the whole muscle meat pieces and the first mixture to a meat processing plant thereby delivering a base meat mixture to the meat processing plant for further processing; and
mixing the base meat mixture with a second mixture.

21. The method of claim 20 wherein the second mixture comprises at least one of:
salt;
sugar;
phosphates;
ascorbate;
sodium erythorbate;
brown sugar;
honey;
flavorings;
mesquite seasonings
sea salt;
vinegar;
sodium lactate;
sodium diacetate; and
liquid smoke flavoring.

22. The method of claim 20 wherein mixing the base meat material comprising a second mixing step comprising a continuous mixing processes wherein the base meat mixture is input at the same time that a whole muscle meat product is output.

23. The method of claim 20 wherein mixing the base meat material comprising a second mixing step comprising a continuous massaging processes wherein the base meat mixture is input at the same time that a whole muscle meat product is output such that during the continuous massaging process a plurality of rotating massaging elements.

24. The method of claim 20 further comprises thermally processing the whole muscle meat product.

25. The method of claim 20 wherein macerating the whole muscle meat pieces to increase the surface area includes passing the whole muscle meat pieces through a gap between a first and a second arbors configured to counter-rotate wherein at least the first arbor has protrusions that extend into channels on the second arbor

26. A method of processing a whole muscle meat product:
providing boneless whole muscle meat;
combining an initial cure mixture with the whole muscle meat and mixing the initial cure mixture and the whole muscle meat to create a raw base mix including the whole muscle meat and the initial cure mixture;
after mixing the initial cure mixture with the whole muscle meat, filling a container with the raw base mix;
transporting the container with the raw base mix to a meat processing plant; and
upon receipt of the raw base mix at the meat processing plant, combining and mixing the raw base mix with a customized ingredient mix and water to produce a processed whole muscle mixture.
